(19) United States
(12) Patent Application Publication
(10) Pub. No.: US 2021/0253400 A1
(43) Pub. Date: Aug. 19, 2021

(54) Bucket Safety Harness

(71) Applicant: Adam Gaulin, Calgary (CA)

(72) Inventor: Adam Gaulin, Calgary (CA)

(21) Appl. No.: 15/704,815

(22) Filed: Sep. 14, 2017

(51) Int. Cl. B66C 1/18

(52) U.S. Cl. CPC B66C 1/18

(57) ABSTRACT

A safety harness for use with a container such as a 5-gallon pail is described. The harness includes vertical and horizontal straps that create a space into which a container can be placed. The straps may be adjusted to fit snugly against outer surface of the container. The harness also includes a connector that can be attached to a separate line to be manipulated by a worker, or attached to a safety belt worn by a worker. The harness provides a simple and safe apparatus that provides easy access to tools and materials, especially for workers operating in above-ground locations.

### FIELD OF THE INVENTION

This invention is in the field of safety equipment, in particular, safety harnesses for using by workers performing above ground tasks.

### BACKGROUND

There are a number of prior art methods in the construction and maintenance industry to provide workers with a place for tools and materials while working in elevated locations, for example, along the side of a building. One such solution is to erect a fixed scaffold structure upon which workers can walk, and store tools and materials. Another is to provide a mobile scaffold that in effectively comprises a cross member than workers can stand on and place tools and materials, and which can be raised or lowered as desired.

The primary drawback of both of these solutions is that they tend to be expensive, and require special equipment to erect and use. There is also the consideration of time and additional personnel involved when using such prior art apparatus and methods, both in their construction and operation. These methods may also be difficult to adapt to work locations were the structure of the building does not readily lend itself to the safe placement of larger scaffold like structure

Thus, what is needed is a simpler apparatus and method for allowing workers to have easy and safe access to tools and materials, and which can readily be used by a single worker.

### SUMMARY OF THE INVENTION

The present disclosure describes a simple, yet effective, safety harness for use in securing a container in which a single worker can place tools and or materials for use particularly in above-ground operations. The harness comprises a vertical strap that is designed to completely encircle a container, for example a 5-gallon pail. One or more horizontal straps encircle the container, and cooperate with the vertical strap in maintaining the container within the interior of the harness. There can be one or more horizontal strap, more than one providing additional laterality stability. The horizontal straps can be adjustable in length, lengthening them to allow easy insertion of the container into the “interior” of the harness, and then shortening them so that they snugly encircle the circumference of the container held within. The vertical strap include a connector to allow a work to connect the harness and container to a line, or in some cases to a safety belt worn by the worker.

The harness may also include a second vertical strap. This strap need not completely encircle the container, but will connect to the one or more horizontal straps to assist in maintaining the container within the harness.

The present disclosure thus provides a safety harness for securing a container: at least one horizontal strap member configured to encircle the outside circumference of the container; wherein the at least one horizontal strap member is adjustable in length and includes a means for tightening the at least one strap member around the container being secured; a first vertical strap member that extends downwards along one side of the container, across a bottom portion of the container, upwards on substantially the opposite side of a container, and across the top of the container, thereby forming a loop encircling the container; wherein the at least one horizontal strap member and first vertical member intersect and are secured to each other at one or more points along the outside surface of the container; at least one connector, the at least one connector configured to secure the first vertical strap member to a line manipulable by a user.

In some embodiments, the safety harness further comprises a second vertical strap member, wherein the second vertical strap member originates at a first location along the at least one horizontal strap member, extends downwards from a location on the at least one horizontal strap member, across the bottom portion of the container, upwards on substantially the opposite of the container, and terminates at a second location on the least one horizontal strap member.

In some embodiments, the first and second locations are separated by approximately half the circumference of the container.

In some embodiments, the safety harness comprises two horizontal strap members.

The present disclosure also provides a method of use of a safety harness, the method comprising: providing a safety harness, the safety harness comprising: at least one horizontal strap member configured to encircle the outside circumference of the container; wherein the at least one horizontal strap member is adjustable in length and includes a means for tightening the at least one strap member around the container being secured; a first vertical strap member that extends downwards along one side of the container, across a bottom portion of the container, upwards on substantially the opposite side of a container, and across the top of the container, thereby forming a loop encircling the container; wherein the at least one horizontal strap member and first vertical member intersect and are secured to each other at one or more points along the outside surface of the container; at least one connector, the at least one connector configured to secure the first vertical strap member to a line manipulable by a user; adjusting the length of the at least one horizontal strap member such that the container can be received by the harness; adjusting the length of the at least one horizontal strap member such that the container is substantially secured within the harness; attaching a line to the connector; and manipulating the line to move the container into a desired location for use.

### BRIEF DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numerals, and where:

FIG. 1A provides a view of an embodiment of a safety harness according to the present disclosure.

FIG. 1B provides a view of an embodiment of a safety harness according to the present disclosure, into which a container has been placed.

### DETAILED DESCRIPTION OF THE INVENTION

The following discussion provides examples of embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed. Those of skill in the art will recognize that the described embodiment are examples of possible configurations of the invention, and are not intended to be limiting to the scope of the invention. Accordingly, the drawings and descriptions contained herein are to be regarded as illustrative of the invention as set forth in the accompanying claims.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The present disclosure relates to preferred embodiments of a safety harness for use by workers performing aerial tasks, and methods of use. In some prior art apparatus and methods, workers are provided with scaffolding that is either assembled as a framework, or mobile scaffolds that can be raised or lowered along the side of a building on which work is to be performed. A variety of tasks may require aerial (above-ground) work, include such things as building construction, and maintenance such as window washing, or repairing widows and other features that are included on buildings. In some cases, mobile scaffolds require specialized installations on the roof of the building to which the lines that secure the scaffold are connected. In addition, even when using a scaffold workers may still need a place into which tools can be placed so that they don't inadvertently fall from the work area, which would otherwise create a significant hazard to those on the ground.

In some cases, the dimensions of a work space are not large enough to accept a typically sized scaffold. In these cases, the challenge is in providing ready access to tools and materials that a worker may need to complete the task at hand.

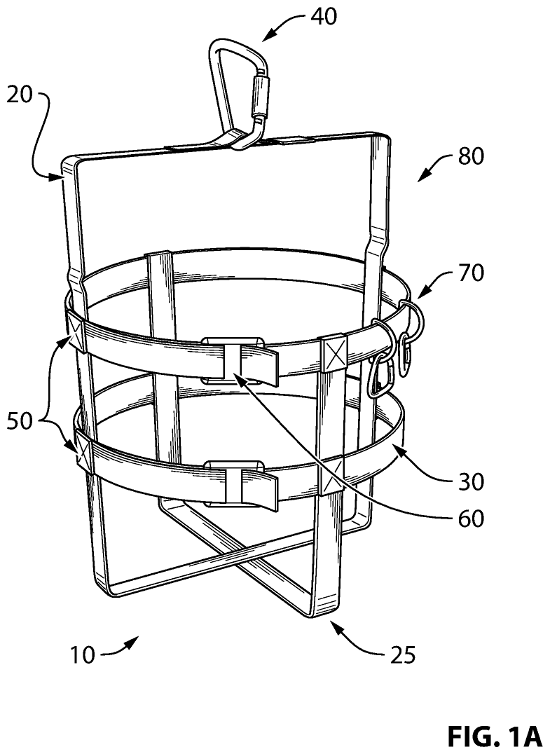

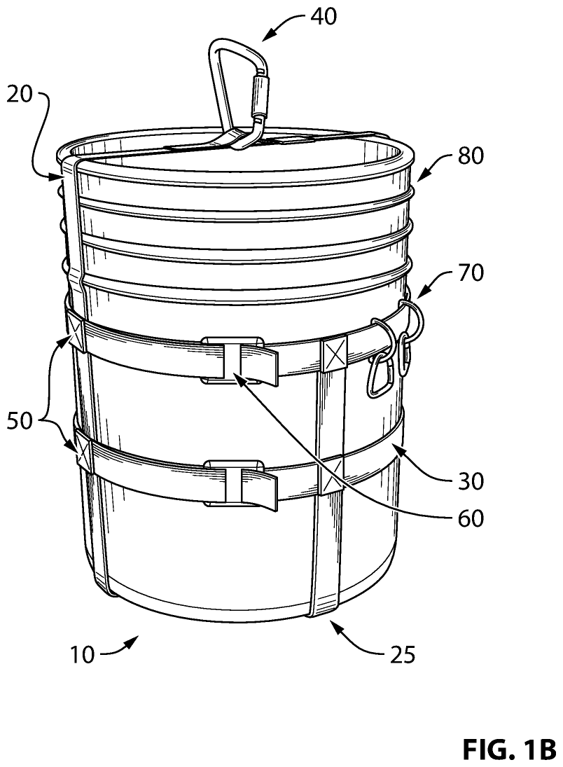

The present disclosure provides a system that is easily used by a single user, and which does not depend on any special fixtures. In one embodiment, there is provided a safety harness system 10 that is adapted to accept and secure in place a container, for example a 5-gallon plastic pail. As depicted in FIGS. 1A and 1B, the safety harness comprises at least one horizontal strap member 30, which is configured and sized to encircle a container 80. The horizontal strap member, and there may be one or more of such members, are meant to encircle the circumference of the container. Each horizontal strap member is designed to be adjustable in length, and includes a means 60 for tightening each horizontal strap so that it fits snugly along the surface of the container. Such tightening means can include devices that the strap will loop in and out of to secure the strap in a desired position, like strap and buckle combinations commonly used in back pack shoulder and waist straps, and the like. In some cases, the strap may include a locking mechanism to prevent the strap from slipping, thus retaining a snug fit to the circumferential size of the container being carried in the harness, and further improving safety when in use.

In addition to the one or more horizontal strap members, there is also a first vertical strap member 20. As most easily appreciated in FIG. 1B, this strap member extends substantially vertically down one side of a container, across the bottom of the container, up the opposite side of the container and then across the top, effectively formed a closed loop that encircles the container in a generally vertically oriented aspect. Where the first vertical strap member intersects, or crosses, a horizontal strap member, the point of intersection 50 can be designed such that the vertical and horizontal strap members are secured to each other. Such securement could be by stitching the two types of members together to form a permanent connection between the two. In other cases, there might be located at the intersection points complimentary loop and hook style fasteners (e.g., Velcro®) to allow the vertical and horizontal strap members to be reversible secured to each other. Both permanent and temporary forms of securing the two types of strap member are included within the scope of the invention as defined by the claims as presented herein.

The safety harness further comprises a second vertical strap member 25. One end of the second vertical strap member will be attached at a first location along at least one horizontal strap member. The second vertical strap member will extend downwards towards the bottom of the safety harness, across where the bottom portion of the container will eventually be positioned (compared FIGS. 1A and 1B), and then upwards on substantially the opposite of the safety harness, terminating at a second location on the least one horizontal strap member. In embodiments of the safety harness have more than one horizontal strap member, a preferred embodiment (illustrated in the FIGURES) will have the second vertical strap member begin and end at locations on the uppermost horizontal strap member. More maximal integrity of the safety harness, the second vertical member can be attached to the horizontal members in much the same way as the vertical horizontal members at points of intersection, as can been seen in the accompanying FIGURES.

The second vertical strap member will generally be positioned such that the spacing from each vertically oriented portion of the second strap member will be roughly equidistant from adjacent vertically oriented portions of the first vertical strap member. Unlike the first vertical strap member, the second vertical strap member need not completely encircle the container that will ultimately be secured within the safety harness. This improves access to the interior of the container so secured. However, it may be desirable for various reasons for both the first and second vertical strap members to completely encircle the container when in use, and such embodiments are contemplated to be within the scope of the present disclosure.

As can also be seen in the drawings, the system also includes a connector 40 that can be used to connect the harness to some other piece of equipment, for example a line operated by a user to raise and lower the harness and container it secures. The connector may also be used to secure the safety harness to a safety belt worn by a user, providing hands-free access to the container and its contents by the user.

In the illustrated embodiment, a safety harness is shown having two horizontal strap members, although other embodiments are contemplated that might have one such strap member, or more than two horizontal strap members.

There is also provided herein a method of using a safety harness as described above to secure a container for use by a worker, particularly in above ground operations. In one embodiment, the method comprises providing a safety harness as described herein. To use the safety harness, a worker will lengthen the horizontal strap member, or members if there are more than one. This can be done by sliding a portion of the strap relative to a buckle. Where a safety catch is included, the catch would first be released to allow the strap to slide through the buckle to increase the effective length of one or more horizontal strap members.

Conveniently, the first vertical strap member can be pushed aside at the top, allowing a worked to then place a container such as a 5-gallon pail into the “interior” of the harness. The container will be placed such that the closed bottom of the container rests on the first and second strap members, such that the weight of the container and its contents can now be supported by said members. The one or more horizontal strap members will encircle the outer circumference of the container. For a more secure fit, the one or more horizontal straps members can now be shortened, the result being that the container will now be held snugly within the confines of the safety harness.

Once the container is secure within the harness, a worker can now attach a line to the connector at the top of the harness. The line can be a rope that the worker or an assistant can manipulate to raise and lower the harness and container, thus moving it to a location where a worker is performing one or more tasks. Alternatively, it may be preferable to connect to connector to a safety belt or other such equipment worn directly by the user. Being able to attach the harness and container to the worker permits the worker to always have the container and its contents conveniently placed for use regardless of where the worker moves at a site where a task is to be performed.

The system can also include one or more secondary connectors 70. In the illustrated embodiment one or more of these secondary connectors can be attached to one of the strap members to provide additional attachment points for other equipment, tools, and the like. These second connectors may be integrated into the strap member, or releasable, such as carabiners and similar types of connectors.

In some embodiments (not illustrated) those of skill in the art will readily appreciate that the space between horizontal and vertical strap members might be covered with a continuous material or even a mesh, to provide additional support, and to further maintain the spatial separation between the various horizontal and vertical strap.

It should also be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A safety harness for securing a container, the safety harness comprising:
a plurality of horizontal strap members configured to encircle the outside circumference of the container, each horizontal strap member comprising a first end and a second end;
wherein at least one of the first and second end comprises a means for the first end to be engaged by the second end;
wherein each horizontal strap member is independently adjustable in length;
wherein, when the first end is engaged by the second end, a horizontal strap member can be varied in length without disengaging the first end from the second end;
a first vertical strap member that extends downwards along one side of the container, across a bottom portion of the container, upwards on substantially the opposite side of a container, and across the top of the container, thereby forming a loop encircling the container; the first vertical strap member further comprising a connector engagement strap, the connector engagement strap having a first end, a second end and a length, the connector engagement strap member secured to the first vertical strap member such that the first and second ends of the connector engagement strap are secured to the first vertical strap member, and at least a portion of the length of the connector engagement strap is not secured to the first vertical strap member, thus forming an opening into which at least one connector can be secured, such that when the at least one connector is secured, it is maintained in a location between the first and second ends of the connector engagement strap, and wherein the at least one connector is configured to secure the first vertical strap member to a line manipulable by a user;
wherein each of the plurality of horizontal strap members intersects with and are secured to the first vertical member at one or more points along the outside surface of the container.

2. The safety harness of claim 1, further comprising a second vertical strap member, wherein the second vertical strap member originates at a first location along at least one of the plurality of horizontal strap members, extends downwards from a location on the at least one of the plurality of horizontal strap members, across the bottom portion of the container, upwards on substantially the opposite of the container, and terminates at a second location on the at least one of the plurality of horizontal strap members.

3. The safety harness of claim 2, wherein the first and second locations are separated by approximately half the circumference of the container.

4. (canceled)

5. A method of using a safety harness for a container, the method comprising:
providing a safety harness, the safety harness comprising:
a plurality of horizontal strap members, each horizontal strap member configured to encircle the outside circumference of the container, each horizontal strap member comprising a first end and a second end;
wherein at least one of the first and second end comprises a means for the first end to be engaged by the second end;
wherein each horizontal strap member is independently adjustable in length;
wherein, when the first end is engaged by the second end, a horizontal strap member can be varied in length without disengaging the first end from the second end;
a first vertical strap member that extends downwards along one side of the container, across a bottom portion of the container, upwards on substantially the opposite side of a container, and across the top of the container, thereby forming a loop encircling the container; the first vertical strap member further comprising a connector engagement strap, the connector engagement strap having a first end, a second end and a length, the connector engagement strap member secured to the first vertical strap member such that the first and second ends of the connector engagement strap are secured to the first vertical strap member, and at least a portion of the length of the connector engagement strap is not secured to the first vertical strap member, thus forming an opening into which at least one connector can be secured, such that when the at least one connector is secured, it is maintained in a location between the first and second ends of the connector engagement strap, and wherein the at least one connector is configured to secure the first vertical strap member to a line manipulable by a user
wherein each of the plurality of horizontal strap members intersects with the first vertical member and are secured to each other at one or more points along the outside surface of the container; and
adjusting the length of at least one of the plurality of horizontal strap members such that the container can be received by the harness;
adjusting the length of the at least one horizontal strap member such that the container is substantially secured within the harness;
attaching a line to the connector; and
manipulating the line to move the container into a desired location for use.
